(19) United States
(12) Patent Application Publication
(10) Pub. No.: US 2009/0029258 A1
(43) Pub. Date: Jan. 29, 2009

(54) PREPARING METHOD OF TIN SULFIDE NANOPARTICLES AND MANUFACTURING METHOD OF LITHIUM ION BATTERY USING THE SAME

(75) Inventors: Jung Wook SEO, Hwaseong (KR); Hyo Seung NAM, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/179,016

(22) Filed: Jul. 24, 2008

(30) Foreign Application Priority Data
Jul. 25, 2007 (KR) 10-2007-0074697

(51) Int. Cl. H01M 4/58

(52) U.S. Cl. 429/231.95; 423/561.1

(57) ABSTRACT

There is provided a method of preparing tin sulfide nanoparticles, in which tin sulfide particles are prepared selectively, easily controlled in size and morphology and can be massively produced more easily through a simpler process. The method includes: mixing a tin sulfide precursor with at least one surfactant into a mixture; and heating the mixture.

### CROSS-REFERENCE TO RELATED APPLICATIONS

This application claims the priority of Korean Patent Application No. 2007-74697 filed on Jul. 25, 2007, in the Korean Intellectual Property Office, the disclosure of which is incorporated herein by reference.

### BACKGROUND OF THE INVENTION

1. Field of the Invention

The present invention relates to a method of preparing tin sulfide nanoparticles and a method of manufacturing a lithium ion battery using the same, and more particularly, to a method of preparing tin sulfide nanoparticles, in which tin sulfide particles are prepared selectively, easily controlled in size and morphology and can be massively produced more easily through a simpler process and at a low cost, and a method of manufacturing a lithium ion battery.

2. Description of the Related Art

Tin sulfide particles are materials for a semiconductor and a photoconductor. The tin sulfide particles are different in physical and chemical properties according to size and morphology thereof. Accordingly, the tin sulfide particles are utilized as materials for a photoelectric device, a solar battery or a holographic optical device and known to be variously applicable.

Also, out of the sulfide particles, SnS₂ nanoparticles are formed of a two-dimensional layered structure, thereby capable of forming intercalation with various materials. Thus, the SnS₂ nanoparticles are expected to find their application in an area such as quantum hall effect or charge density wave using a two-dimensional nano material.

Moreover, the tin sulfide particles can be used as a source of tin when lithium and tin are formed into an alloy. In a case where the tin sulfide particles are used as an electrode, LiₓS generated may serve as a buffer material to enhance electrode characteristics.

As conventional methods to prepare metal sulfide nanoparticles, a metal precursor has been thermally decomposed, or decomposed by a laser or electromagnetic waves. Also, a hydrogen sulfide gas and a metal oxide have reacted to each other or a metal ion and a sulfur ion have reacted to each other in a high-temperature solution. Here, to obtain the nanoparticles massively, which are controlled uniformly in size and morphology and superior in crystallinity, the nanoparticles need to be prepared in a high-temperature solution.

To manufacture tin sulfide nanoparticles, SnS₂ powder is formed as pellets and then nanoparticles composed of SnS₂/SnS are produced by laser ablation, as disclosed in Tenne, R. J. Am. Chem. Soc., 2003, vol. 125, p. 10470. The nanoparticles obtained are shaped as fullerene having a round or edged shape. The tin sulfide nanoparticles are represented by SnSₓ, where x ranges from 1.3 to 1.6, and SnS₂ and SnS are irregularly arranged in one particle. Therefore, with this technology, SnS₂ and SnS can be neither produced selectively nor controlled in size and morphology. Besides, this technology requires expensive equipment, thus entailing high costs in synthesizing nanoparticles massively.

In another technology, a tin chloride precursor is mixed with thiourea and then a microwave is irradiated to form SnS and SnS₂. The SnS and SnS₂ are dried in an oven for four hours to prepare nanoparticles, as disclosed in Qian, Y. T. Journal of Crystal Growth, 2004, vol. 260, p. 469. This technology allows the SnS and SnS₂ to be produced selectively according to a tin oxidation number of tin chloride and have superior crystallinity of particles. However, the nanoparticles obtained have a very large size, i.e., micrometer and are non-uniform in size distribution and morphology.

In an alternative technology, tin chloride (II), Na₂S and toluene are mixed in an autoclave and heated at 150° C. for 6 to 8 hours to synthesize nanoparticles, as disclosed in Qian, X. F. J. Physics and Chemistry of Solids, 1999, vol. 60, p. 415. The nanoparticles obtained by this technology have a size of about 12 nm, which is relatively superior in size characteristics, but are very non-uniform in morphology. Moreover, this technology involves a very long reaction time and demonstrates aggregation of nanoparticles.

As described above, technologies for preparing tin sulfide nanoparticles include employing additional high-priced equipment to utilize an external energy, that is, irradiate electromagnetic wave, laser beam and ultrasonic waves, and synthesizing the tin sulfide nanoparticles by increasing pressure out of reaction conditions. These technologies require high-priced special equipment and involve a long reaction time. Besides, the nanoparticles by these technologies are non-uniform in size and morphology and entail high costs to be synthesized massively. In addition, to prepare SnS and SnS₂ nanoparticles, tin precursors with different oxidation numbers should be employed independently.

Also, an attempt has been made to apply tin sulfide nanoparticles to a cathode of a lithium ion battery, as taught in Osaka, T. J. Power Sources, 2003, vol. 119-121, p. 60-63. In this attempt, tin chloride (II) as a precursor and thioacetamide are mixed together and an ultrasonic wave is irradiated to produce tin sulfide nanoparticles having a relatively large size of 400 to 900 nm and a small size of 30 nm according to concentration of the precursor.

Here, the synthesized nanoparticles exhibit a biggest battery capacity of 319 mAh/g when having a smallest size of 30 nm. Also, the synthesized nanoparticles, when heat-treated, are increased in battery capacity to 409 mAh/g. However, the synthesized nanoparticles are very non-uniform in size and morphology and have battery capacity constantly decreasing with increase in the cycle numbers. Furthermore, the synthesized nanoparticles show retention characteristics of less than 50%.

Therefore, there has been a consistent demand for developing a method of producing tin sulfide nanoparticles massively at a low cost and controlling size and morphology of the tin sulfide nanoparticles produced.

### SUMMARY OF THE INVENTION

An aspect of the present invention provides a method of preparing tin sulfide nanoparticles, in which tin sulfide particles are prepared selectively and easily controlled in size and morphology.

An aspect of the present invention also provides a method of preparing tin sulfide nanoparticles, in which tin sulfide particles can be massively produced more easily through a simpler process and at a low cost.

An aspect of the present invention also provides a method of manufacturing a high-capacity lithium ion battery superior in electrode characteristics.

According to an aspect of the present invention, there is provided a method of preparing tin sulfide nanoparticles, the method including: mixing a tin sulfide precursor with at least one surfactant into a mixture; and heating the mixture. Here, the tin sulfide nanoparticles may include one selected from a group consisting of SnS, SnS₂ and SnₐS_{b}, where 1≦a≦4 and 1≦b≦5.

The tin sulfide precursor may be a single precursor containing tin or sulfur. The tin sulfide precursor may be dual precursors containing a tin precursor and a sulfur precursor. The single precursor may include a tin carbamate-based compound represented by (Sn(S₂CNCₙH₂ₙ₊₁)ₘ, where 1≦n≦10, and m is 2 or 4. The single precursor may include at least one selected from (Ph₃Sn)₂S, where Ph is a phenyl group, (BZ₂SnS)₃, where Bz is a benzyl group, Sn(SCₙH₂ₙS)₂, where 1≦n≦10 and ((CₙH₂ₙ₊₁)₂NCS₂)ₘ(RSS)₄₋ₘSn, where 0≦m≦4 and 1≦n≦10.

The tin precursor may include at least one compound selected from a group consisting of tin halide, tin acetate, tin acetoacetate and alkyl tin. The sulfur precursor may include at least one selected from a group consisting of phenyl sulfide, alkyl sulfide, thioamide, carbon disulfide and hydrogen sulfide.

The surfactant may include at least one amine-based surfactant, and the tin sulfide may be SnS₂. The amine-based surfactant may be added at 80 wt % or more based on a total weight of the surfactant. The amine-based surfactant maybe an organic amine represented by CₙNH₂, where 4≦n≦30. The organic amine may include one selected from a group consisting of oleyl amine, dodecyl amine, lauryl amine, octyl amine, trioctyl amine, dioctyl amine and hexadecyl amine.

The surfactant may be at least one amine-based surfactant and at least one thiol-based surfactant, and the tin sulfide may be SnS. The amine-based surfactant may be added at 5 wt % to 20 wt % based on a total weight of the surfactant. The thiol-based surfactant is added at 60 wt % to 95 wt % based on a total weight of the surfactant.

The thiol-based surfactant may be an alkan thiol represented by CₙSH, where 4≦n≦30. The alkan thiol may include one selected from a group consisting of hexadecane thiol, dodecane thiol, heptadecane thiol and octadecane thiol.

The heating the mixture may include heating the mixture to a temperature of 50 to 450° C.

The heating the mixture may include heating the mixture for 1 minute to 4 hours.

The mixture may further include at least one solvent, wherein the solvent is an organic solvent. The organic solvent may include one selected from a group consisting of an ether-based solvent, a hydro carbon-based solvent and an organic acid-based solvent. Here, the ether-based solvent may include one selected from a group consisting of octyl ether, benzyl ether and phenyl ether. The hydro carbon-based solvent may include one selected from a group consisting of hexadecane, heptadecane and octadecane. The organic acid-based solvent may include one selected from a group consisting of oleic acid, lauric acid, stearic acid, mysteric acid and hexadecanoic acid.

A ratio of the tin sulfide precursor to the surfactant in the mixture may range from 1:8 to 1:70. Also, a ratio of the tin sulfide precursor to the solvent in the mixture may range from 1:5 to 1:50.

According to another aspect of the present invention, there is provided a method of manufacturing a lithium ion battery including: forming the tin sulfide nanoparticles prepared by the method defined above as a cathode and a lithium electrode as an anode.

The method may further include heat-treating the separated tin sulfide nanoparticles, after the separating the tin sulfide nanoparticles. The heat-treating the separated tin sulfide nanoparticles may be performed at a temperature of 400° C. to 750° C.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a lithium ion battery manufactured according to an exemplary embodiment of the invention;

FIG. 2 is a transmission electron microscope (TEM) observation result of SnS₂ nanoparticles prepared according to an exemplary embodiment of the invention.

FIG. 3 is a scanning electron microscope (SEM) observation result of SnS₂ nanoparticles prepared according to an exemplary embodiment of the invention.

FIG. 4 is a tilting analysis result of SnS₂ nanoparticles prepared according to an exemplary embodiment of the invention and observed using a TEM;

FIGS. 5A and 5B are TEM observation results of SnS₂ nanoparticles prepared according to an exemplary embodiment of the invention;

FIG. 6 is an analysis result of X-ray diffraction patterns of SnS₂ nanoparticles prepared according to an exemplary embodiment of the invention;

FIG. 7 is an energy analysis result of SnS₂ nanoparticles prepared according to an exemplary embodiment of the invention;

FIG. 8 is a TEM analysis result of SnS₂ nanoparticles prepared massively according to an exemplary embodiment of the invention;

FIG. 9 is a TEM analysis result of SnS₂ nanoparticles prepared massively according to an exemplary embodiment of the invention;

FIG. 10 is a SEM analysis result of SnS₂ nanoparticles prepared according to an exemplary embodiment of the invention;

FIG. 11 is a high-voltage high-resolution TEM analysis result of SnS₂ nanoparticles prepared according to an exemplary embodiment of the invention;

FIG. 12 is an analysis result of X-ray diffraction patterns illustrating SnS₂ nanoparticles prepared according to an exemplary embodiment of the invention;

FIG. 13 is a discharge capacity result of a lithium ion battery manufactured using SnS₂ nanoparticles prepared according to an exemplary embodiment of the invention with respect to the cycle numbers;

FIG. 14 is a voltage profile analysis result of a lithium ion battery manufactured using SnS₂ nanoparticles prepared according to an exemplary embodiment of the invention with respect to discharge capacity;

FIG. 15 is a discharge capacity result of a lithium ion battery manufactured using SnS₂ nanoparticles prepared according to an exemplary embodiment of the invention with respect to the cycle numbers; and

FIG. 16 is a voltage profile analysis result of a lithium ion battery manufactured using SnS₂ nanoparticles prepared according to an exemplary embodiment of the invention with respect to discharge capacity.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity.

To prepare tin sulfide nanoparticles according to an exemplary embodiment of the invention, first, a tin sulfide precursor is mixed with at least one surfactant into a mixture, and then the mixture is heated. The tin sulfide nanoparticles break down into various kinds of tin sulfides according to the oxidation number of tin, and can be prepared as at least one particle selected from SnS, SnS₂ and Sn_{aSb}, where 1≦a≦4, and 1≦b≦5. The type of tin sulfide nanoparticles can be adjusted according to a surfactant mixed and a type of a solvent that may be further added, and a mixing ratio thereof. This will be described further hereinafter.

A tin sulfide precursor applicable to the present embodiment is a single precursor or dual precursors. Here, the single precursor is a compound containing tin and sulfur as well. Thus, with use of only the single precursor, tin sulfide containing tin and sulfur can be produced.

An example of the single precursor applicable to the present embodiment includes a tin carbamate compound represented by (Sn(S₂CNCₙH₂ₙ₊₁)ₘ), where 1≦n≦10, and m is 2 or 4. Also, the single precursor may adopt an organic metal compound selected from (Ph₃Sn)₂S, where Ph is a phenyl group, (Bz₂SnS)₃, where Bz is a benzyl group, Sn(SCₙH₂ₙS)₂, where n is 1≦n≦10 and ((CₙH₂ₙ₊₁)₂NCS₂)ₘ(RSS)₄₋ₘSn, where 0≦m≦4 and 1≦n≦10.

All of these compounds contain tin and sulfur to be utilized as a tin source and a sulfur source. Therefore, in preparing the tin sulfide nanoparticles according to the present embodiment, the tin sulfide precursor may employ any compound that can be used as a tin source and a sulfur source.

The dual precursors are a tin sulfide precursor containing a tin precursor and a sulfur precursor independently. The dual precursors are a tin source and a sulfur source, respectively, and mixed independently with a surfactant or mixed with the surfactant in combination.

The tin precursor may adopt a tin halide-based compound represented by SnXₐ, where X═Cl, Br, F, or I, and a is 2 or 4, tin acetate, tin acetoacetate, or alkyl tin represented by CₙH₂₊₁Sn, where 1≦n≦10, but the present invention is not limited thereto. Also, the sulfur precursor may utilize a phenyl sulfide compound represented by PhSSPh, where Ph is a phenyl group, an alkyl sulfide compound represented by CₙH₂ₙ₊₁SSCₙH₂ₙ₊₁, where 1≦n≦10, thioamide, CₙH₂ₙ₊₁CSNH₂, where 1≦n≦10, carbon disulfide, or hydrogen sulfide, but the present invention is not limited thereto.

In preparing the tin sulfide nanoparticles according to the present embodiment, the tin sulfide precursor is mixed with at least one surfactant. The surfactant disperses the tin sulfide precursor, and helps to allow the tin precursor and sulfur precursor to be detached from or re-combined with the tin sulfide precursor.

The surfactant applicable to the present invention includes but limited to a surfactant containing an electron-rich functional group such as NH₂and SH. In this case, such a surfactant attacks bonds within the tin precursor and the sulfur precursor which are combined as a compound in the tin sulfide precursor to separate them into tin sulfur nanoparticles. Therefore, the surfactant may adopt an amine-based surfactant or thiol-based surfactant containing such a functional group.

The amine-based surfactant applicable to the present embodiment may employ an organic amine represented by CₙNH₂, where 4≦n≦30. Examples of the organic amine may include but not limited to oleyl amine, dodecyl amine, lauryl amine, octyl amine, trioctyl amine, dioctyl amine or hexadecyl amine.

The thiol-based surfactant applicable to the present embodiment may utilize an alkane thiol, represented by CₙSH, where 4≦n≦30. Examples of the alkane thiol may include but not limited to hexadecane thiol, dodecane thiol, heptadecane thiol and octadecane thiol,

In a case where SnS₂ tin sulfide nanoparticles may be mainly prepared, the surfactant may adopt the amine-based surfactant. Alternatively, in a case where SnS tin sulfide nanoparticles may be chiefly prepared, the surfactant may employ the amine-based surfactant and the thiol-based surfactant in combination. This selectivity is considered to result from differences in reactivity and reaction mechanism between an amine group in the amine-based surfactant and the tin sulfide precursor and between a thiol group in the thiol-based surfactant and the tin sulfide precursor, respectively. Accordingly, the type of the surfactant may be adjusted to selectively produce the tin sulfide nanoparticles.

In a case where the desired tin sulfide nanoparticles are SnS₂, the amine-based surfactant may be employed as the surfactant. This is because the amine group in the amine-based surfactant increases a selectivity ratio of SnS₂ in the tin sulfide nanoparticles. Thus, to obtain SnS₂, the amine-based surfactant may be added in a great amount of at least 80 wt % based on a total weight of the surfactant. The amine-based surfactant may be added in an amount of, particularly, at least 90 wt %, and more particularly, 95 wt % to 100 wt %. Also, in a case where a solvent is contained in addition to the surfactant, the amine-based surfactant may be added in an amount of at least 80 wt % based on a total weight of a solution. The amine-based surfactant may be added in an amount of, particularly, at least 90 wt %, and more particularly, 95 wt % to 100 wt %.

Meanwhile, in order to obtain SnS tin sulfide nanoparticles, the amine-based surfactant and the thiol-based surfactant as well may be used. Here, out of the total surfactant, the amine-based surfactant may be added in an amount of 5 wt % to 20 wt % based on a total weight of the surfactant. The thiol-based surfactant may be added in an amount of 60 wt % to 95 wt % based on a total weight of the surfactant. The thiol-based surfactant may be added in an amount of, particularly, 70 wt % to 90 wt %, and more particularly, 75 wt % to 85 wt %.

In preparing the tin sulfide nanoparticles according to the present embodiment, a solvent may be further contained in addition to the tin sulfide precursor and the surfactant. The solvent is adjusted in a mixing ratio with the surfactant according to the type of the desired tin sulfide nanoparticles. The mixture may further contain at least one solvent. The solvent applicable to the preparation method of the tin sulfide nanoparticles according to the present embodiment includes but not limited to an organic solvent.

The organic solvent may adopt but not limited to an ether-based solvent represented by CₙOCₙ, where 4≦n≦30, such as octyl ether, benzyl ether, and phenyl ether, a hydrocarbon-based solvent represented by CₙH₂ₙ₊₁, where 7≦n≦30, such as hexadecane, heptadecane, octadecane, and an organic acid-based solvent represented by CₙCOOH, where 5≦n≦30, such as oleic acid, lauric acid, stearic acid, mysteric acid or hexadecanoic acid.

The tin sulfide precursor and the surfactant are added in a weight ratio ranging from 1:1 to 1:100, particularly 1:5 to 1:80, and more particularly, 1:8 to 1:70. Also, in a case where a solvent is further added in the mixture, the tin sulfide precursor and the solvent are added in a weight ratio ranging from 1:1 to 1:200, particularly, 1:2 to 1:70, and more particularly, 1:5 to 1:50.

After the tin sulfide precursor and the surfactant are mixed together with the mixture, the mixture is heated to thermally decompose the tin sulfide precursor. The mixture, when the surfactant and solvent are further contained therein, may be heated at a heating temperature of about 50° C. to 450° C. considering characteristics of the solvent. The heating temperature may range from 100° C. to 400° C., more particularly, 120° C. to 350° C. The mixture may be heated for about 1 minute to four hours to ensure the tin sulfide precursor to be sufficiently thermally decomposed in view of characteristics of the mixed tin sulfide precursor, surfactant and solvent.

A method of manufacturing a lithium ion battery using tin sulfide nanoparticles obtained by the preparation method of tin sulfide nanoparticles according to an exemplary embodiment of the invention will be described hereinafter. In manufacturing the lithium battery according to the present embodiment, a tin sulfide precursor is mixed with a surfactant containing at least one of an amine-based surfactant and a thiol-based surfactant into a mixture. The mixture is heated. Tin sulfide nanoparticles are separated from the heated mixture The tin sulfide nanoparticles are formed as a cathode and a lithium electrode is formed as an anode. The method of mixing the tin sulfide precursor with the surfactant and heating the mixture to prepare the tin sulfide nanoparticles is the same as described above and thus will be omitted.

When the mixture is heated to produce the tin sulfide nanoparticles, the tin sulfide nanoparticles are separated from the mixture. The nanoparticles may be separated by a known method in the art. For example, a predetermined amount of solvent such as ethanol or acetone is added into the mixture to precipitate the tin sulfide nanoparticles and then the precipitated tin sulfide nanoparticles can be separated using a centrifuge.

The separated tin sulfide nanoparticles are formed as a cathode of the lithium ion battery, while the lithium electrode is formed as an anode, thereby manufacturing the lithium ion battery. When the tin sulfide nanoparticles are separated, the separated tin sulfide nanoparticles are heat-treated to remove impurities therefrom. The heat-treatment temperature may range from 400° C. to 750° C. according to type and characteristics of impurities such as the solvent in a case where the surfactant and solvent are contained.

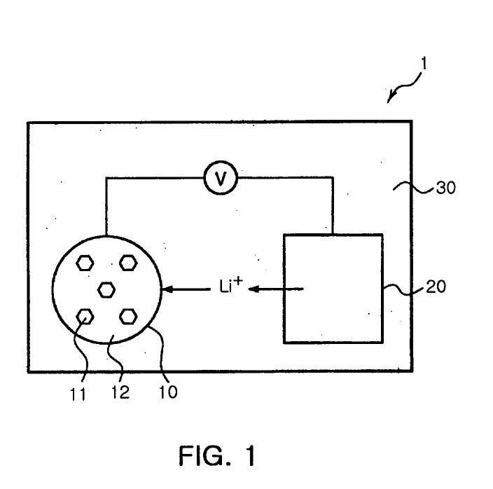

FIG. 1 illustrates a lithium ion battery 1 manufactured according to an exemplary embodiment of the invention. An electrode 10 composed of tin sulfide nanoparticles 11 is a working electrode serving as a cathode and an electrode 20 formed of lithium is a counter electrode. The lithium ion battery 1 may further include an electrolyte 30 to ensure electrical conduction. The tin sulfide nanoparticles 11 constitute a desired electrode structure along with a binder 12 to serve as the electrode. To act as the working electrode, the tin sulfide nanoparticles 11 may be distributed uniformly in the electrode. The tin sulfide nanoparticles 11 are prepared according to an exemplary embodiment of the invention, and thus uniform in size and morphology and superior in crystallinity, accordingly exhibiting excellent characteristics as the working electrode.

### EXAMPLES

Hereinafter, the present invention will be described in further detail by way of following Examples. In Examples 1 and 2, SnS₂ nanoparticles were prepared according to an exemplary embodiment of the invention. In Example 3, SnS nanoparticles were prepared according to an exemplary embodiment of the invention. Then, in Example 4, a lithium ion battery having a cathode formed of the SnS2 nanoparticles prepared in Example 1 was measured for characteristics. In Example 5, a lithium ion battery having a cathode formed of the SnS nanoparticles prepared in Example 3 was measured for characteristics.

### Example 1

### Preparing SnS₂ Nanoparticles

60 mg of Sn(S₂CNEt₂)₄ as a tin sulfide precursor was mixed with 5 ml of oleyl amine to prepare a mixture. The mixture was heated at 280° C. for 10 minutes to be thermally decomposed. After tin sulfide nanoparticles were sufficiently formed, 6 mL of toluene and 20 mL of acetone were added to the mixture and the mixture was centrifuged using a centrifuge to produce SnS₂ nanoparticles.

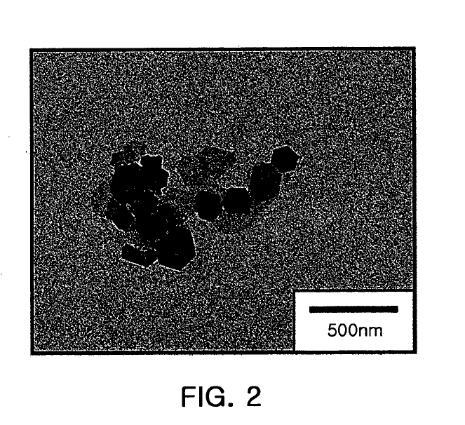

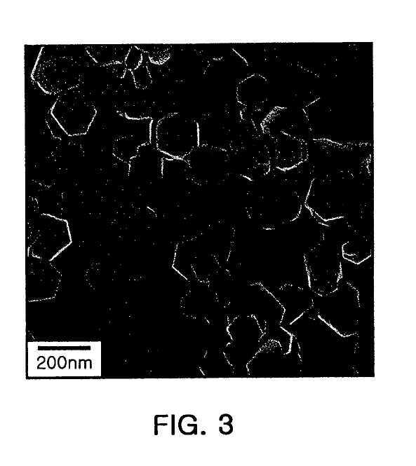

A sample was prepared by dropping 20 μl of solution containing the obtained SnS₂ nanoparticles on a TEM grid (made by Ted Pella Inc.) having a carbon film applied thereon. The sample was dried for about 30 minutes, and observed with a field emission transmission electron microscope (FE-TEM), which is made by Zeiss and has an accelerating voltage of 100 kV. The result is shown in FIG. 2. Also, powder of SnS₂ nanoparticles was observed by a scanning electron microscope (SEM) and the result is shown in FIG. 3.

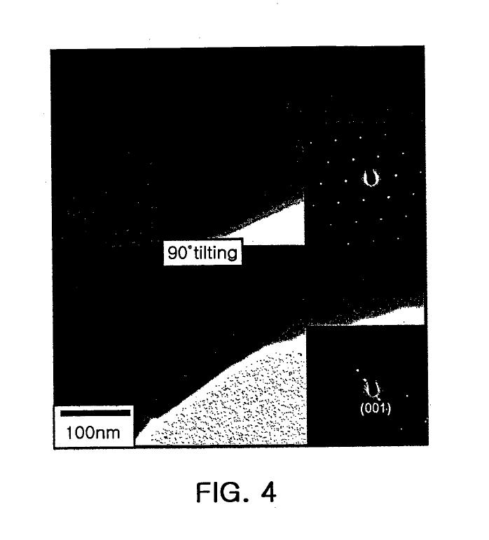

Referring to FIGS. 2 and 3, the prepared SnS₂ nanoparticles were observed to be of a hexagonal plate shape. Also, the SnS₂ nanoparticles were observed with a TEM, and a sample holder was tilted to observe shape change and thickness of the nanoparticles. The result is shown in FIG. 4. The nanoparticles observed with the TEM were found to be of a hexagonal plate shape when the sample is placed evenly on the grid. Meanwhile, the nanoparticles were found to be of a rod shape when the sample was tilted at a right angle. Therefore, the tin sulfide nanoparticles prepared by the preparation method of the tin sulfide nanoparticles according to an exemplary embodiment of the invention are superb in crystallinity.

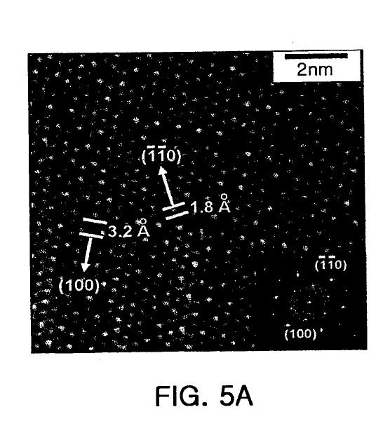

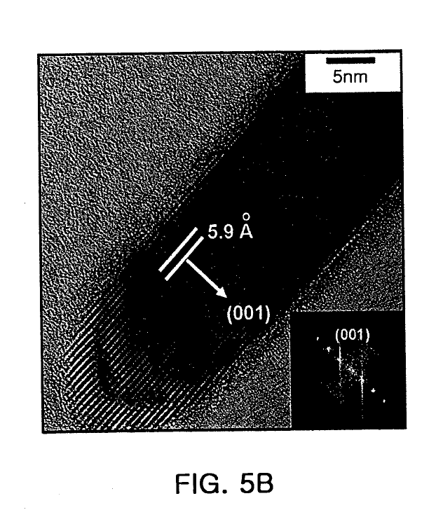

Moreover, the SnS₂ nanoparticles were observed under a high voltage high-resolution TEM, which is made by Jeol Inc. and has an accelerating voltage of 1250 kV, and the results are shown in FIGS. 5A and 5B. The plate-shaped nanoparticles obtained were identical in interlattice distance to a hexagonal 2 H crystal structure. Also, rod-shaped nanoparticles standing perpendicular to the grid, when observed with the high-resolution TEM, were found to be identical in interplanar distance to a (001) plane, and be of a layered structure. Moreover, as a result of electron diffraction analysis and high-resolution TEM analysis, the synthesized nanoparticles were found to be of a hexagonal single-crystal structure.

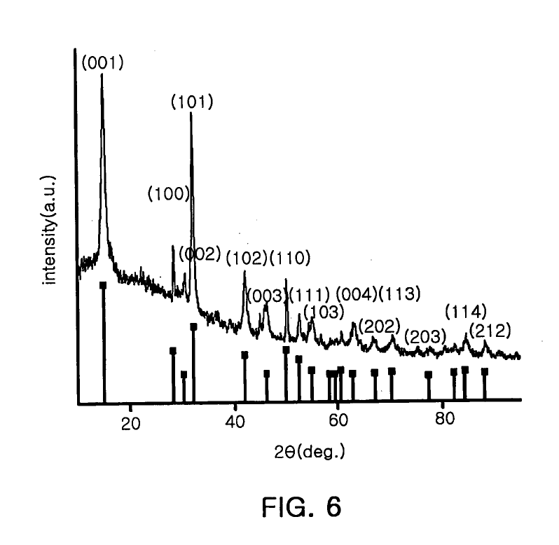

In addition to the TEM analysis, the tin sulfide nanoparticles were analyzed for a crystal structure using an X-ray diffraction analyzer (XRD), which is made by Rikagu, and the results are shown in FIG. 6. Referring to FIG. 6, perpendicular lines located in a lower part of the graph represent standard values, i.e., JDPDS card #: 23-677 when analyzed for diffraction. Also, numbers in parentheses denote crystal planes.

Referring to FIGS. 2 to 6, the SnS₂ nanoparticles prepared according to an exemplary embodiment of the invention are superior in crystallinity and have a hexagonal 2H layered crystal structure.

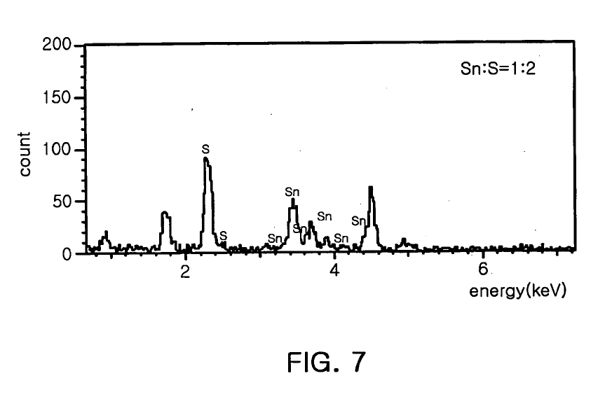

To identify the type of the tin sulfide nanoparticles, an energy dispersive spectrum, (EDS) analysis was conducted. The analysis found that out of the prepared SnS₂ nanoparticles, a ratio between tin and sulfur was 1:2 and thus the tin sulfide nanoparticles prepared using the amine-based surfactant were SnS₂. The result is shown in FIG. 7.

### Example 2

### Synthesizing SnS₂ Nanoparticles Massively

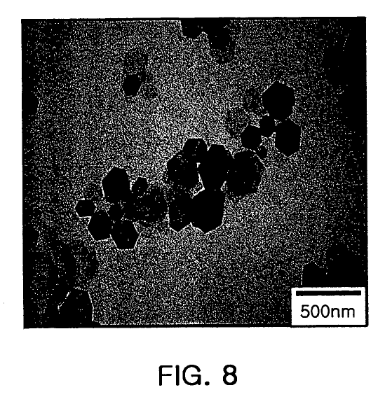

In Example 2, tin sulfide nanoparticles were prepared identically to Example 1 except that 3 g of Sn(S₂CNEt₂)₄ 3 which is 50 times greater in the amount was employed as a tin sulfide precursor. The SnS₂ nanoparticles prepared were observed with the TEM and the result is shown in FIG. 8. Referring to FIG. 8, the SnS₂ nanoparticles, even though produced massively, had a hexagonal plate shape. Therefore, according to the preparation method of the present invention, even when the tin sulfide nanoparticles were synthesized massively, nanoparticles with superb crystallinity were produced.

### Example 3

### Preparing SnS Nanoparticles

Tin sulfide nanoparticles were prepared identically to Example 1 except that 1 mL of oleyl amine and 4 mL of dodecane thiol were employed as a surfactant.

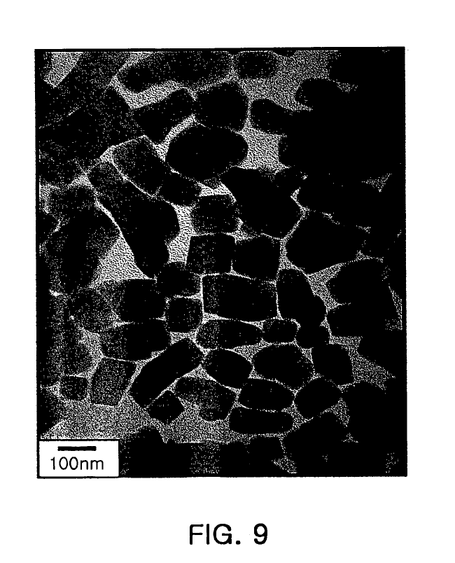

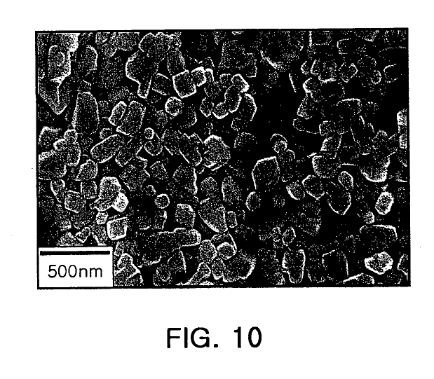

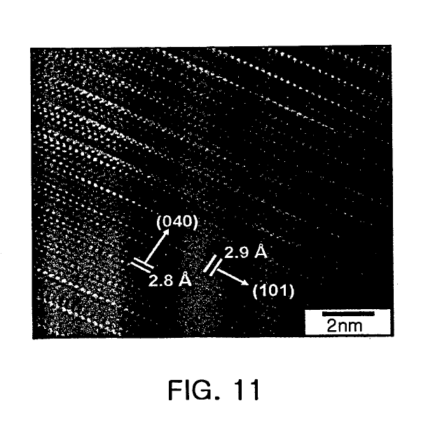

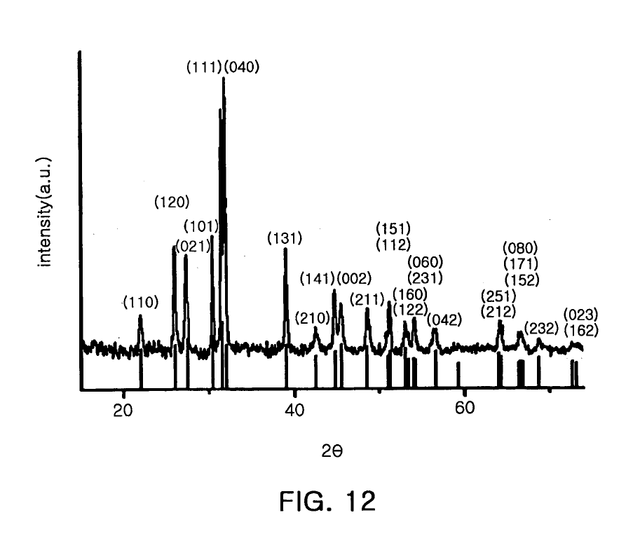

The tin sulfide nanoparticles obtained were observed with the TEM and SEM, and the results are shown in FIGS. 9 and 10, respectively. Referring to FIG. 9, the synthesized tin sulfide nanoparticles were shaped as a brick, and unlike Example 1, SnS nanoparticles were produced. The SnS nanoparticles had a size of about 50 nm to 150 nm. The nanoparticles were observed with a high-voltage high resolution TEM and the result is shown in FIG. 11. As a result of analysis, the SnS nanoparticles were found to be a single crystal and identical in interlattice distance to an orthorhombic structure. Also, FIG. 12 illustrates X-ray diffraction analysis results of the nanoparticles, and demonstrates that the nanoparticles are identical to the orthorhombic crystal structure. Referring to FIG. 12, perpendicular lines located in a lower part of the graph represent standard values, i.e., JDPDS card #: 39-0354 when analyzed for diffraction. Also, numbers in parentheses denote crystal planes.

Referring to FIGS. 9 to 12, the SnS nanoparticles prepared according to Example 3 are superior in crystallinity and have a single crystal orthorhombic structure.

### Example 4

### Manufacturing a Lithium Ion Battery

In Example 4, a lithium ion battery was manufactured according to an exemplary embodiment of the invention and measured for charge and discharge capacity. As the lithium ion battery, a 2012 type coin cell battery was manufactured by a known method in the art and subjected to measurement.

### Electrode Characteristics of Lithium Ion Battery of SnS₂ Nanoparticles

To measure electrode characteristics of the lithium ion battery using the SnS₂ nanoparticles, a tin sulfide working electrode was manufactured as described below. To remove organic materials from a surface of the tin sulfide nanoparticles prepared according to Example 1, the tin sulfide nanoparticles were heat treated for one hour at 500° C. Then the tin sulfide nanoparticles, super P carbon black and polyvinylidene fluoride binder were mixed in a weight ratio of 8:1:1 and pelleted to form a working electrode. As a counter electrode, a known lithium electrode was employed to manufacture a 2012-type coin cell battery.

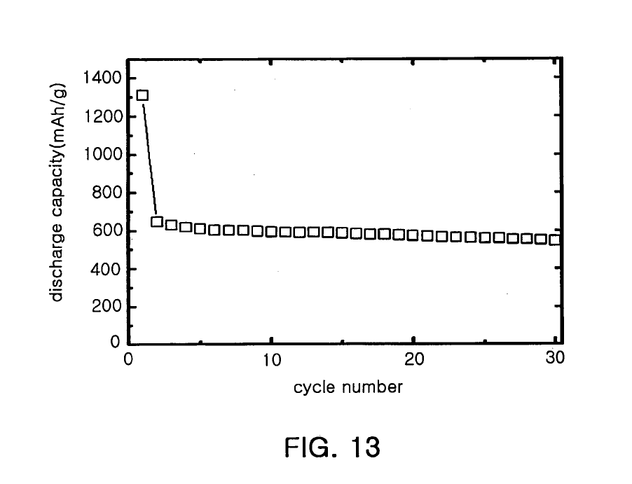

Moreover, LiPF₆ was added into a solution having ethylene carbonate and diethylene carbonate mixed in a volume ratio of 1:1 to produce 1M of LiPF₆ organic electrolyte. Electrode characteristics of the lithium ion battery were measured up to 30 cycles at a constant current of 50 mA/g and in a voltage ranging from 5 mV to 2 V. FIG. 13 shows charge and discharge characteristics of the SnS₂ nanoparticles with respect to the cycle numbers. Referring to FIG. 13, reversible charge and discharge characteristics of 645 mAh/g were plotted in the second cycle, i.e., identical to theoretical discharge capacity (645 mAh/g). Thus, the lithium ion battery showed the discharge capacity about 1.7 times higher than the discharge capacity of the general carbon electrode, which is 372 mAh/g. Average capacity up to 30 cycles was observed to be about 607 mAh/g.

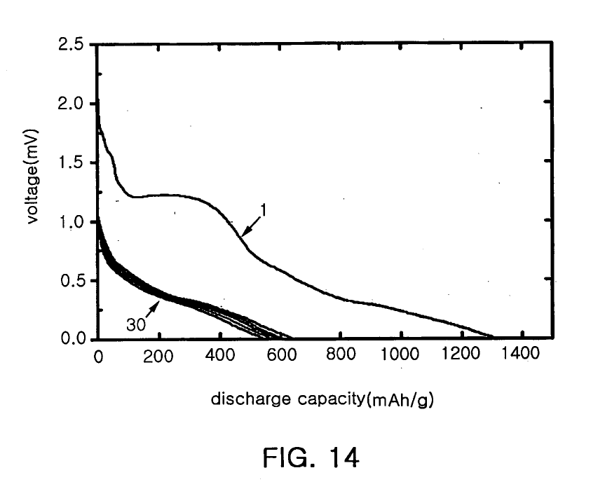

Meanwhile, FIG. 14 shows a voltage profile of the SnS₂ nanoparticles as a working electrode (lithium electrode as a counter electrode). FIG. 14 illustrates graphs representing first and thirtieth cycles, respectively and also a plurality of graphs representing second, fifth, tenth and twentieth cycles between the two graphs. Referring to FIG. 14, the lithium ion battery exhibits charge conservation properties of at least 85% up to the thirtieth cycle.

### Example 5

### Electrode Characteristics of Lithium Ion Battery of SnS Nanoparticles

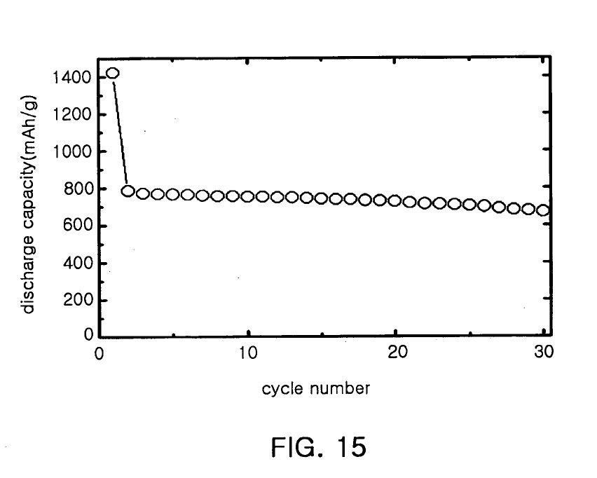

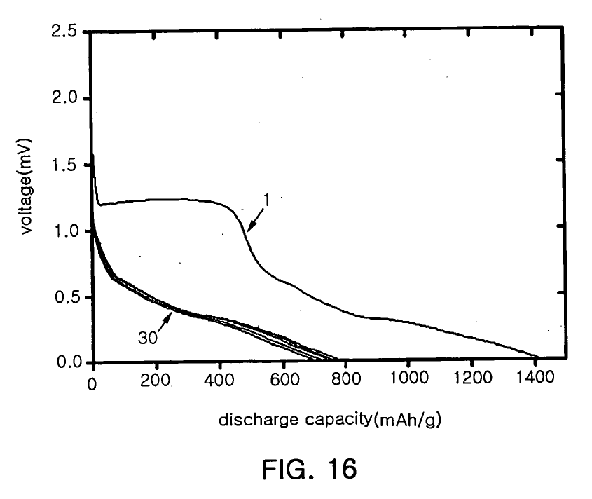

A lithium ion battery was manufactured identically to Example 4 except that SnS was employed as tin sulfide nanoparticles in place of SnS₂. FIGS. 15 and 16 represent battery capacity with respect to the cycle numbers and a voltage profile of the SnS nanoparticles as a working electrode (lithium electrode as a counter electrode), respectively. In the same manner as FIG. 14, FIG. 16 illustrates graphs representing initial first and final thirtieth cycles, respectively and a plurality of graphs representing second, fifth, tenth and twentieth cycles between the two graphs.

As in Example 4, the SnS electrode exhibits an average capacity of about 755 mAh/g up to the thirtieth cycle, which is about twice higher than capacity of a general carbon electrode. Also, the lithium ion battery exhibits charge conservation properties of at least 85% up to thirtieth cycle.

As can be seen in Examples 4 and 5, the lithium ion battery manufactured using the tin sulfide nanoparticles prepared according to the present invention demonstrates superior characteristics. That is, the charge and discharge capacity is 1.7 to 2.0 times higher than the conventional carbon electrode and the charge conservation rate is at least 85% up to the thirtieth cycle.

As set forth above, according to exemplary embodiments of the invention, tin sulfide nanoparticles can be prepared through a relatively simpler process without entailing expensive equipment to ensure superior characteristics.

That is, the desired type of tin sulfide nanoparticles can be selectively prepared and easily adjusted in size and morphology, and superior in crystallinity.

In addition, the tin sulfide nanoparticles prepared according to the present invention are applicable to various fields. Particularly, when the tin sulfide nanoparticles are utilized as a cathode of a lithium ion battery, the electrode exhibits superior characteristics due to excellent crystallinity and uniform morphology and size of the tin sulfide nanoparticles. This can increase capacity of the lithium ion battery and enhance quality and reliability of the product.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of preparing tin sulfide nanoparticles, the method comprising:
mixing a tin sulfide precursor with at least one surfactant into a mixture; and
heating the mixture.

2. The method of claim 1, wherein the tin sulfide nanoparticles comprise one selected from a group consisting of SnS, SnS₂ and SnₐS_{b}, where 1≦a≦4 and 1≦b≦5.

3. The method of claim 1, wherein the tin sulfide precursor is a single precursor containing tin or sulfur.

4. The method of claim 3, wherein the single precursor comprises a tin carbamate-based compound represented by (Sn(S₂CNCₙH₂ₙ₊₁)ₘ, where 1≦n≦10, and m is 2 or 4.

5. The method of claim 3, wherein the single precursor comprises at least one selected from (Ph₃Sn)₂S, where Ph is a phenyl group, (BZ₂SnS)₃, where Bz is a benzyl group, Sn(SCₙH₂ₙS)₂, where 1≦n≦10 and ((CₙH₂ₙ₊₁)₂NCS₂)ₘ(RSS)₄₋ₘSn, where 0≦m≦4 and 1≦n≦10.

6. The method of claim 1, wherein the tin sulfide precursor is dual precursors containing a tin precursor and a sulfur precursor.

7. The method of claim 6, wherein the tin precursor comprises at least one compound selected from a group consisting of tin halide, tin acetate, tin acetoacetate and alkyl tin.

8. The method of claim 7, wherein the tin halide-based compound is represented by SnXₐ, where X is one of Cl, Br, F and I, and a is 2 or 4.

9. The method of claim 7, wherein the alkyl tin is represented by CₙH₂ₙ₊₁Sn, where 1≦n≦10.

10. The method of claim 6, wherein the sulfur precursor comprises at least one selected from a group consisting of phenyl sulfide, alkyl sulfide, thioamide, carbon disulfide and hydrogen sulfide.

11. The method of claim 1, wherein the surfactant comprises at least one amine-based surfactant, and the tin sulfide comprises SnS₂.

12. The method of claim 11, wherein the amine-based surfactant is added at 80 wt % or more based on a total weight of the surfactant.

13. The method of claim 11, wherein the amine-based surfactant comprises an organic amine represented by CₙNH₂, where 4≦n≦30.

14. The method of claim 13, wherein the organic amine comprises one selected from a group consisting of oleyl amine, dodecyl amine, lauryl amine, octyl amine, trioctyl amine, dioctyl amine and hexadecyl amine.

15. The method of claim 1, wherein the surfactant comprises at least one amine-based surfactant and at least one thiol-based surfactant, and
the tin sulfide comprises SnS.

16. The method of claim 15, wherein the amine-based surfactant is added at 5 wt % to 20 wt % based on a total weight of the surfactant.

17. The method of claim 15, wherein the thiol-based surfactant is added at 60 wt % to 95 wt % based on a total weight of the surfactant.

18. The method of claim 15, wherein the thiol-based surfactant comprises an alkan thiol represented by CₙSH, where 4≦n≦30.

19. The method of claim 18, wherein the alkan thiol comprises one selected from a group consisting of hexadecane thiol, dodecane thiol, heptadecane thiol and octadecane thiol.

20. The method of claim 1, wherein the heating the mixture comprises heating the mixture to a temperature of 50 to 450° C.

21. The method of claim 1, wherein the heating the mixture comprises heating the mixture for 1 minute to 4 hours.

22. The method of claim 1, wherein the mixture further comprises at least one solvent,
wherein the solvent is an organic solvent.

23. The method of claim 22, wherein the organic solvent comprises one selected from a group consisting of an ether-based solvent, a hydro carbon-based solvent and an organic acid-based solvent.

24. The method of claim 23, wherein the ether-based solvent comprises one selected from a group consisting of octyl ether, benzyl ether and phenyl ether.

25. The method of claim 23, wherein the hydro carbon-based solvent comprises one selected from a group consisting of hexadecane, heptadecane and octadecane.

26. The method of claim 23, wherein the organic acid-based solvent comprises one selected from a group consisting of oleic acid, lauric acid, stearic acid, mysteric acid and hexadecanoic acid.

27. The method of claim 1, wherein a ratio of the tin sulfide precursor to the surfactant in the mixture ranges from 1:8 to 1:70.

28. The method of claim 22, wherein a ratio of the tin sulfide precursor to the solvent in the mixture ranges from 1:5 to 1:50.

29. A method of manufacturing a lithium ion battery, the method comprising:
mixing a tin sulfide precursor with a surfactant containing at least one of an amine-based surfactant and a thiol-based surfactant into a mixture;
heating the mixture;
separating tin sulfide nanoparticles from the heated mixture; and
forming the tin sulfide nanoparticles as a cathode and a lithium electrode as an anode.

30. The method of claim 29, further comprising heat-treating the separated tin sulfide nanoparticles, after the separating the tin sulfide nanoparticles.

31. The method of claim 30, wherein the heat-treating the separated tin sulfide nanoparticles is performed at a temperature of 400° C. to 750° C.
